(19) United States
(12) Patent Application Publication
(10) Pub. No.: US 2022/0391497 A1
(43) Pub. Date: Dec. 8, 2022

(54) DATA ANOMALY STATISTICAL ALARM METHOD AND DEVICE, AND ELECTRONIC EQUIPMENT

(71) Applicants: Gree Electric Appliances, Inc. of Zhuhai, Zhuhai, Guangdong (CN); Leayun Technology Co., Ltd. of Zhuhai, Zhuhai, Guangdong (CN)

(72) Inventors: Haosheng Lin, Zhuhai, Guangdong (CN); Bo Wang, Zhuhai, Guangdong (CN); Shasha Lv, Zhuhai, Guangdong (CN); Zehan Tan, Zhuhai, Guangdong (CN); Qiang Guo, Zhuhai, Guangdong (CN); Kanglong Zhang, Zhuhai, Guangdong (CN)

(21) Appl. No.: 17/771,726

(22) PCT Filed: Dec. 31, 2019
(86) PCT No.: PCT/CN2019/130341

§ 371 Date: Apr. 25, 2022

(30) Foreign Application Priority Data
Nov. 20, 2019 (CN) 201911142964.9

(51) Int. Cl. G06F 21/55

(52) U.S. Cl. CPC G06F 21/552; G06F 2221/034

(57) ABSTRACT

The present disclosure relates to the technical field of data anomaly detection and alarm, and more particularly, to a data anomaly statistics and alarm method and apparatus, and an electronic device, which effectively relieve the problem of alarm missing in the related technologies, thereby effectively avoiding the loss of enterprises due to alarm missing, the method includes: acquiring a detection time and a detection result of each of a plurality of data respectively through detecting; counting the number of target data in a current time window, and generating an alarm signal to prompt in response to the number of target data obtained by the counting being greater than a preset number threshold corresponding to a quality level of the data; moving the current time window backward according to a stepping duration included in an obtained stepping duration setting rule corresponding to the quality level of the data, and the current time window moved backward is used as a new current time window.

### CROSS-REFERENCE TO RELATED APPLICATION

The present disclosure claims priority of Chinese patent application No. 201911142964.9, entitled “DATA ANOMALY STATISTICS AND ALARM METHOD AND APPARATUS, AND ELECTRONIC DEVICE”, filed on Nov. 20, 2019, the entire contents of which are incorporated herein by reference.

### TECHNICAL FIELD

The present disclosure relates to the technical field of data anomaly detection and alarm, and more particularly, to a data anomaly statistics and alarm method and apparatus, and an electronic device.

### BACKGROUND

Currently, the quality of the information of different parts or devices in the manufacturing industry or the information exchanged in the information interaction (referred to as “data” in the present disclosure) will have different effects on the overall quality of the result of the product or data interaction. The quality requirements for critical data and accident-related data must be the most stringent, while for some secondary data, the quality requirements can be appropriately lowered.

And for the quality evaluation of data, the traditional method is to calculate the results according to each natural day, each week, each month and other time periods, and then give an evaluation based on the results. The supplier data quality alarm uses regular statistics and evaluation of supplier data quality, and compares it with a preset threshold, if the statistical result reaches or exceeds the threshold, an alarm is triggered. For example: the system pre-sets data A provided by a certain supplier, and the when the pass rate of the weekly sampling inspection is smaller than 98%, an alarm is triggered; or when the number of unqualified items in the daily sampling inspection is greater than 5, an alarm is triggered, and so on. Specifically, the previous week's Sunday 00:00:00 to the next Sunday 00:00:00 is used as a week to count the supplier data sampling pass rate, or 00:00:00 to 00:00:00 of the next day is used as one day to count the number of unqualified supplier data sampling inspections, the data will be divided according to the front and back cycle dividing line at 00:00:00 of every Sunday or 00:00:00 of every day, and then summary statistics will be performed separately.

According to the inventor's research, taking the alarm of unqualified total number per day as an example, if collect statistics and alarms on a natural day cycle, the following problems will exist: when the sum of the number of unqualified products detected in a supplier's data A is sufficient to trigger the alarm condition in the vicinity of the boundary crossing the two time periods before and after, however, since it is near the boundary of the two time periods before and after, the statistics will be split into two parts and included in the two time periods before and after, which may cause the number of unqualified in the two days before and after to fail to meet the alarm condition, and the alarm will not be triggered, and thereby being ignored, and causing certain losses to the enterprise.

### SUMMARY

Based on the foregoing, the present disclosure provides a data anomaly statistics and alarm method and apparatus, and an electronic device, by counting the number of anomalous data by adopting a time window, and generating alarm information according to the number and quality type of anomalous data for warning, effectively relieve the problem of alarm missing in the related technologies, thereby effectively avoiding the loss of enterprises due to alarm missing.

In a first aspect, the present disclosure provides a data anomaly statistics and alarm method, which includes:

step a: acquiring a detection time and a detection result of each of a plurality of data respectively through detecting;

step b: counting the number of target data in a current time window, and generating an alarm signal to prompt in response to the number of target data obtained by the counting being greater than a preset number threshold corresponding to a quality level of the data, wherein the target data is the one with the detection result being anomalous;

step c: moving the current time window backward according to an obtained stepping duration setting rule corresponding to the quality level of the data, the current time window moved backward is used as a new current time window, and returning to step a.

In some embodiments, the method further includes:

acquiring the number of alarm signals generated within a preset period of time;

the step of moving the current time window backward according to an obtained stepping duration setting rule corresponding to the quality level of the data comprises:

acquiring a target stepping duration corresponding to the number from the stepping duration rule corresponding to the quality level of the data, wherein, the stepping duration setting rule comprises a plurality of preset numbers of alarm signals generated within the preset duration and a stepping duration corresponding to each of the plurality of preset numbers;

moving the current time window backward according to the target stepping duration.

In some embodiments, in the data anomaly statistics and alarm method, acquiring a detection time and a detection result of each of a plurality of data respectively through detecting comprises:

acquiring the detection time and the detection result of each of the plurality of data respectively through detecting multiple data within a set duration threshold before a current time, wherein, the set duration threshold is greater than a time window length of the current time window, and a starting time of the current time window is within the set duration threshold before the current time.

In some embodiments, in the data anomaly statistics and alarm method, the quality level of the data comprises a first level, a second level, and a third level, and the first level is superior to the second level, and the second level is superior to the third level.

In some embodiments, the stepping duration corresponding to the data of the first level is less than the stepping duration corresponding to the data of the second level, the stepping duration corresponding to the data of the second level is less than the stepping duration corresponding to the data of the third level.

In some embodiments, in the data anomaly statistics and alarm method, the time window length of the current time window is one day or two days, and the stepping duration corresponding to the data of the first level is ten minutes, twenty minutes or one hour, the stepping duration corresponding to the data of the second level is four hours or half a day, and the stepping duration corresponding to the data of the third level is one day or two days.

In some embodiments, in the data anomaly statistics and alarm method, the preset number threshold corresponding to the data of the first level is smaller than the preset number threshold corresponding to the data of the second level, the preset number threshold corresponding to the data of the second level is smaller than the preset number threshold corresponding to the third level of data.

In some embodiments, in the data anomaly statistics and alarm method, acquiring a detection time and a detection result of each of a plurality of data respectively through detecting comprises: acquiring the detection time and the detection result of each of the plurality of data respectively through detecting at every interval set duration, wherein the set duration is less than or equal to the stepping duration.

In a second aspect, the present disclosure provides a data anomaly statistics and alarm apparatus, comprising a processor, wherein the processor is configured to execute the following program modules stored in a memory:

an information acquiring module configured to acquire a detection time and a detection result of each of a plurality of data respectively through detecting;

an anomaly statistics and alarm module configured to count the number of target data in a current time window, and generate an alarm signal to prompt in response to the number of target data obtained by the counting being greater than a preset number threshold corresponding to a quality level of the data, wherein the target data is the one with the detection result being anomalous;

a time window setting module configured to move the current time window backward according to an obtained stepping duration setting rule corresponding to the quality level of the data, wherein the current time window moved backward is used as a new current time window.

In a third aspect, the present disclosure provides a storage medium storing a computer program which, when executed by one or more processors, causes the one or more processors to perform the above data anomaly statistics and alarm method.

In a fourth aspect, the present disclosure provides an electronic device, which includes a memory and a processor, and a computer program is stored on the memory, when the computer program is executed by the processor, the data anomaly statistics and alarm method applied to the first terminal is performed.

The present disclosure provides a data anomaly statistics and alarm method and apparatus, and an electronic device, by acquiring a detection time and a detection result of each of a plurality of data respectively through detecting, counting the number of target data in a current time window, and generating an alarm signal to prompt in response to the number of target data obtained by the counting being greater than a preset number threshold corresponding to a quality level of the data, wherein the target data is the one with the detection result being anomalous, and moving the current time window backward according to an obtained stepping duration setting rule corresponding to the quality level of the data, the current time window moved backward is used as a new current time window to perform statistical alarm on anomalous target data again, and through the above method, realizing the use of time window to count the number of anomalous data, and according to the number and quality of the anomalous data, the alarm information is generated for alarm, which effectively relieve the problem of alarm missing in the related technologies, thereby effectively avoiding the loss of enterprises due to alarm missing.

### BRIEF DESCRIPTION OF DRAWINGS

In order to more clearly describe the technical solutions in the embodiments of the present disclosure or related technologies, the following will briefly introduce the accompanying drawings that need to be used in the description of the embodiments or related technologies. Apparently, the drawings in the following description are only embodiments of the present disclosure, for those of ordinary skill in the art, other drawings can be obtained from the disclosed drawings without creative work.

FIG. 1 is a schematic flowchart of a data anomaly statistics and alarm method provided by some embodiments of the present disclosure.

FIG. 2 is a schematic diagram of time window statistics when performing anomaly statistics on the first type of data provided by some embodiments of the present disclosure.

FIG. 3 is a schematic diagram of time window statistics when performing anomaly statistics on the second type of data provided by some embodiments of the present disclosure.

FIG. 4 is a schematic diagram of time window statistics when performing anomaly statistics on the third type of data provided by some embodiments of the present disclosure.

In the drawings, the same components use the same reference numerals, and the drawings are not necessarily drawn according to actual scale.

### DETAILED DESCRIPTION

Hereinafter, the implementation of the present disclosure will be described in detail with reference to the accompanying drawings and embodiments, for fully understanding and implementing the implementation process of how the present disclosure applies technical means to solve the technical problems and achieve corresponding technical effects. The embodiments of the present disclosure and various features in the embodiments can be combined with each other under the premise of no conflict, and the formed technical solutions are all within the protection scope of the present disclosure.

### Embodiment One

The data anomaly statistics and alarm method provided by the present disclosure uses a sliding time window to count the number of target data whose detection results are anomalous among a plurality of detected data in different time windows, and when the number of the target data is greater than the preset threshold corresponding to the quality level of the data, an alarm signal is generated to prompt the user, thereby effectively relieving the problem of inaccurate statistics of anomalous data in related technologies.

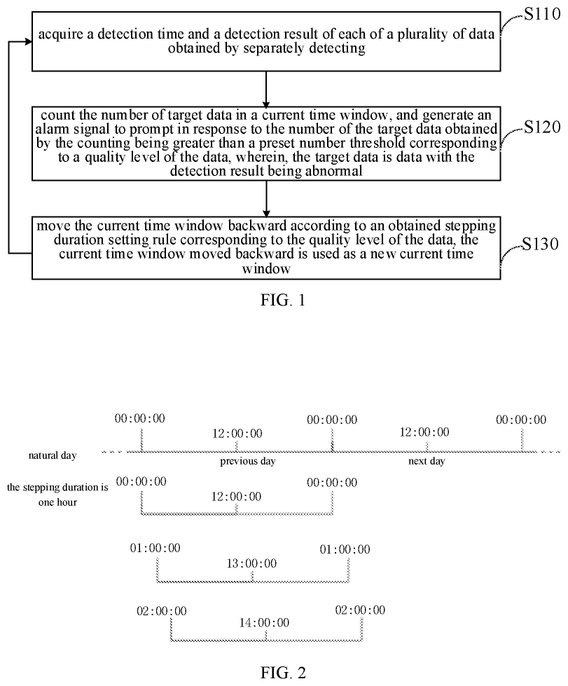

Referring to FIG. 1, the present disclosure provides a data anomaly statistics and alarm method, which can be applied to electronic devices with data processing capabilities such as computers, servers, or tablets. When the data anomaly statistics and alarm method is applied to the electronic device, the steps of S110 to S140 may be executed.

In step S110: acquiring a detection time and a detection result of each of a plurality of data respectively through detecting.

In step S120: counting the number of target data in a current time window, and generating an alarm signal to prompt in response to the number of target data obtained by the counting being greater than a preset number threshold corresponding to a quality level of the data, wherein the target data is the one with the detection result being anomalous.

In step S130: moving the current time window backward according to an obtained stepping duration setting rule corresponding to the quality level of the data, the current time window moved backward is used as a new current time window, and returning to step S110.

In the above step S110, the method of acquiring the detection time and the detection result may be to receive the detection time and the detection result input by the user, it may also be the detection time and the detection result stored in the device for acquiring the detection data, which is not specifically limited here, and can be set according to actual needs.

When the method of acquiring the detection time and detection result stored in the data device is adopted, the method can be that the detection time and detection result of the data are acquired in real time, or the detection time and detection result of data are acquired at every interval set duration, it may also be that the detection result of the data within the set duration threshold range before the current time.

In this embodiment, the above step S110 may be acquiring the detection time and the detection result of each of the plurality of data respectively through detecting at every interval set duration, wherein the set duration is less than or equal to the stepping duration.

In this embodiment, the above step S110 may also be acquiring the detection time and the detection result of each of the plurality of data respectively through detecting multiple data within a set duration threshold before a current time, wherein, the set duration threshold is greater than a time window length of the current time window, and a starting time of the current time window is within the set duration threshold before the current time.

The set duration may be one week, one month, several months or one year, which is not specifically limited here.

In step S120, the time window length of the current time window can be one hour, several hours, one day, two days, or one week, which is not specifically limited here, and can be set according to actual needs. The preset number threshold may be several, tens or hundreds, which is not specifically limited here, and can be set according to actual needs. The starting time of the current time window may be within one day.

In this embodiment, the time window length of the current time window may be one day or two days.

It should be understood that the way of generating an alarm signal for prompting can also be to generate an alarm signal when the ratio of the number of target data to the number of all data detected by the time window length of the current time window is greater than a preset value.

The quality level of the data may include a plurality of quality levels, and the degrees of different quality levels are different, for example, the quality level of the data may include the most-best quality level (first level), the best quality level (second level), the next-best quality level (third level), and the general quality level (fourth level), it should be understood that the quality level of the data may also include more or less levels, which are not specifically limited here.

In some embodiments, the quality level of the data includes a first level, a second level, and a third level, and the quality of the data of the first level is superior to the quality of the data of the second level, and the quality of the data of the second level is superior to the quality of the data of the third level.

It should be understood that when data detection is carried out, the detection efficiency of the data detection device should be the same. In the case of the higher the quality level of the data, the smaller the number of target data detected in the same time period (within the same time window).

In some embodiments, the preset number threshold corresponding to the data of the first level of is smaller than the preset number threshold corresponding to the data of the second level, the preset number threshold corresponding to the data of the second level is smaller than the preset number threshold corresponding to the data of the third level.

In step S130, the stepping duration setting rule may include a stepping duration, and the stepping duration may be, but not limited to, five minutes, ten minutes, tens of minutes, several hours, tens of hours, one day or several days. The stepping duration setting rule may also include the stepping duration corresponding to different statistical numbers under the corresponding quality level, it may also include different stepping durations corresponding to different time periods at the corresponding quality level, and may also include the stepping durations corresponding to different alarm numbers generated within a preset duration at the corresponding quality level. It should be understood that different data quality levels have different early warning requirements, therefore, different quality levels correspond to different stepping duration. It should be understood that the higher the quality level of the data, the higher the quality level is usually required. Therefore, in this embodiment, the stepping duration corresponding to the data of the first level is less than the stepping duration corresponding to the data of the second level, the stepping duration corresponding to the data of the second level is less than the stepping duration corresponding to the data of the third level.

In this embodiment, the stepping duration corresponding to the data of the first level is ten minutes, twenty minutes or one hour, the stepping duration corresponding to the data of the second level is four hours or half a day, and the stepping duration corresponding to the data of the third level is one day or two days.

By taking the current time window moved backward as the new current time window, and returning to step S110, a high-precision data anomaly statistics and alarm through the time window is realized.

In order to facilitate the statistics of anomalous data at different stepping durations in different time periods, in this embodiment, the preset statistical rule includes a plurality of time periods under the corresponding quality level and the stepping duration corresponding to each of the plurality of time periods, and the step of moving the current time window backward according to an obtained stepping duration setting rule corresponding to the quality level of the data includes: determining the target time period to which the starting time of the current time window belongs and the target stepping duration corresponding to the target time period, from the stepping duration setting rule corresponding to the quality level of the data, and moving the current time window backward according to the target stepping duration.

In order to facilitate the execution of data anomaly statistics according to different stepping durations under different statistical numbers, by performing counting the number of target data in the current time window, or after performing the above steps, the number of times of counting the quality of the target data in the current time window is obtained, in step S130: moving the current time window backward according to the obtained stepping duration setting rule corresponding to the quality level of the data includes: acquiring the target stepping duration corresponding to the statistical number from the stepping duration rule corresponding to the quality level of the data, wherein, the stepping duration setting rule includes a plurality of statistical numbers and a stepping duration corresponding to each of the statistical numbers, and the current time window is moved backward according to the target stepping duration.

In order to facilitate data anomaly statistics by determining the corresponding stepping duration according to the number of alarms generated within the preset duration, in this embodiment, the preset statistical rule includes preset stepping durations corresponding to different preset alarm numbers within the preset duration, by performing statistics on the number of target data in the current time window, or after performing the above steps, the number of alarm signals generated within a preset period of time is obtained, obtaining the target stepping duration corresponding to the number from the stepping duration rule corresponding to the quality level of the data, wherein, the stepping duration setting rule includes a plurality of preset numbers of generating an alarm signal within a preset duration and a stepping duration corresponding to each of the preset numbers, and the current time window is moved backward according to the target stepping duration.

It should be understood that the greater the number of preset alarms generated within the preset period of time, the shorter the corresponding preset stepping duration should be, so as to promptly remind the user that the data is anomalous and facilitate the user to deal with it.

The present disclosure perform the above steps S110-S130 to implement anomalous data statistics and early alarm in different time windows by using different stepping duration setting rules according to different data quality levels, thereby effectively alleviating the problem of missing alarms when using natural day or natural week data anomalous statistical warnings in related technologies, and thereby effectively improving the real-time nature of the alarm, so that users can respond to the alarm information in time, thereby effectively avoiding the loss of enterprises due to alarm missing.

### Embodiment Two

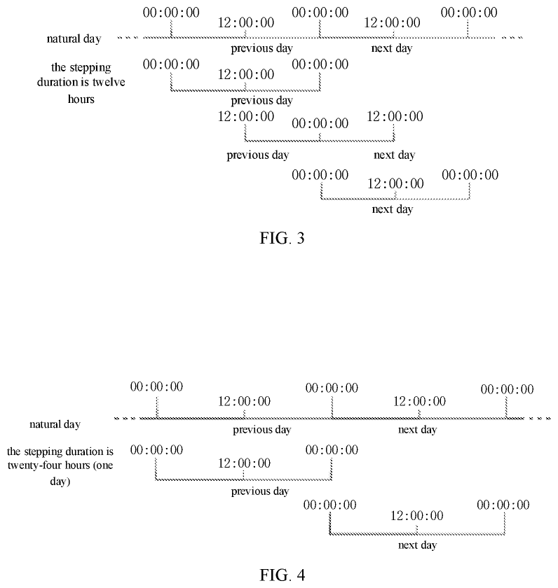

Referring to FIG. 2, FIG. 3, and FIG. 4 in combination, in this embodiment, the time window length of the current time window is one day. The quality level includes the first level, the second level and the third level, and the stepping duration corresponding to the quality level includes that the stepping duration corresponding to the first level is one hour, the stepping duration corresponding to the second level is half a day and the stepping duration corresponding to the third level is one day as an example for description.

Referring to FIG. 1, when the quality level is the first level, acquiring the detection time and the detection result of each of a plurality of data separately detected in a natural day, and counting the number of target data within 24 hours when the starting time in the current time is after 00:00:00 of the previous day in a natural day, when the number of the target data is greater than the preset number threshold corresponding to the first quality level, an alarm signal is generated, and according to the stepping duration (one hour) included in the stepping duration setting rule corresponding to the quality level of the data, the starting time of the current time window is shifted backward, and the backward shift duration is the stepping duration (one hour), and use the shifted starting time (00:01:00 on the previous day in a natural day) as the starting time of the new current time window, and return to the step of acquiring the detection time and the detection result of each of a plurality of data separately detected in a natural day, thereby realizing the counting of the number of target data within 24 hours through dividing time, and the duration of the dividing time is one hour, thereby effectively avoiding the loss of enterprises due to alarm missing.

Referring to FIG. 3, when the quality level is the first level, acquiring the detection time and the detection result of each of a plurality of data separately detected in a natural day, and counting the number of target data within 24 hours when the starting time in the current time is after 00:00:00 of the previous day in a natural day, when the number of the target data is greater than the preset number threshold corresponding to the first quality level, an alarm signal is generated, and according to the stepping duration (twelve hours) included in the stepping duration setting rule corresponding to the quality level of the data, the starting time of the current time window is shifted backward, and the backward shift duration is the stepping duration (twelve hours), and use the shifted starting time (00:12:00 on the previous day in a natural day) as the starting time of the new current time window, and return to the step of acquiring the detection time and the detection result of each of a plurality of data separately detected in a natural day, thereby realizing the counting of the number of target data within 24 hours through dislocation overlapping, and the duration of the dividing time is twelve hours, thereby effectively avoiding the loss of enterprises due to alarm missing.

Referring to FIG. 4, when the quality level is the third level, acquiring the detection time and the detection result of each of a plurality of data separately detected in a natural day, and counting the number of target data within 24 hours when the starting time in the current time is after 00:00:00 of the previous day in a natural day, when the number of the target data is greater than the preset number threshold corresponding to the first quality level, an alarm signal is generated, and according to the stepping duration (one day) included in the stepping duration setting rule corresponding to the quality level of the data, the starting time of the current time window is shifted backward, and the backward shift duration is the stepping duration (one day), and use the shifted starting time (00:00:00 on the next day in a natural day) as the starting time of the new current time window, and return to the step of acquiring the detection time and the detection result of each of a plurality of data separately detected in a natural day, thereby realizing the counting of the number of target data within 24 hours through dividing time period, and the duration of the dividing time is one day, thereby effectively avoiding the loss of enterprises due to alarm missing.

### Embodiment Three

The embodiment of the present disclosure also provides a data anomaly statistics and alarm apparatus, including a processor, wherein the processor is configured to execute the following program modules stored in a memory:

an information acquiring module configured to acquire a detection time and a detection result of each of a plurality of data respectively through detecting;

since the implementation principle of the information acquiring module is similar to that of step S110 in FIG. 1, no further description will be given here;

an anomaly statistics and alarm module configured to count the number of target data in a current time window, and generate an alarm signal to prompt in response to the number of target data obtained by the counting being greater than a preset number threshold corresponding to a quality level of the data, wherein the target data is the one with the detection result being anomalous;

since the implementation principle of the anomaly statistics and alarm module is similar to that of step S120 in FIG. 1, no further description will be given here;

a time window setting module configured to move the current time window backward according to an obtained stepping duration setting rule corresponding to the quality level of the data, wherein the current time window moved backward is used as a new current time window;

Since the implementation principle of the time window setting module is similar to that of steps S130 and S140 in FIG. 1, no further description will be given here.

### Embodiment Four

This embodiment also provides a computer-readable storage medium, such as flash memory, hard disk, multimedia card, card-type memory (for example, SD or DX memory, etc.), Random Access Memory (RAM), Static Random Access Memory (SRAM), Read Only Memory (ROM), Electrically Erasable Programmable Read Only Memory (EEPROM), Programmable Read Only Memory (PROM), Magnetic storage, magnetic disks, optical disks, servers, App application store and so on, a computer program is stored thereon, and when the computer program is executed by a processor, the method steps in the first embodiment can be realized.

The specific embodiment process of the above method steps can be referred to the embodiment one, which will not be repeated here in this embodiment.

### Embodiment Five

The embodiment of the present disclosure provides a terminal device, including a memory and a processor, wherein, when the computer program stored in the memory is executed by the processor, the data anomaly statistics and alarm method in the first embodiment is performed.

The specific embodiment process of the above method steps can be referred to the first embodiment, which will not be repeated here in this embodiment.

In summary, the present disclosure provides a data anomaly statistics and alarm method and apparatus, and an electronic device, by acquiring a detection time and a detection result of each of a plurality of data respectively through detecting, counting the number of target data in a current time window, and generating an alarm signal to prompt in response to the number of target data obtained by the counting being greater than a preset number threshold corresponding to a quality level of the data, wherein the target data is the one with the detection result being anomalous, and moving the current time window backward according to an obtained stepping duration setting rule corresponding to the quality level of the data, the current time window moved backward is used as a new current time window, thereby realizing the use of time window to count the number of anomalous data, and according to the number and quality of the anomalous data, the alarm information is generated for alarm, which effectively relieve the problem of alarm missing in the related technologies, thereby effectively avoiding the loss of enterprises due to alarm missing.

In the several embodiments provided in the embodiments of the present disclosure, it should be understood that the disclosed system and method may also be implemented in other ways. The system and method embodiments described above are merely illustrative.

It should be noted that in this article, the terms “comprise”, “include” or any other variants thereof are intended to cover non-exclusive inclusion, so that a process, method, article or device including a series of elements not only includes those elements, and also includes other elements that are not explicitly listed, or elements inherent to the process, method, article, or device. If there are no more restrictions, the element defined by the sentence “comprise one . . . ” does not exclude the existence of other identical elements in the process, method, article, or device that includes the element.

Although the embodiments disclosed in the present disclosure are as above, the content described is only the embodiments used to facilitate the understanding of the present disclosure, and is not intended to limit the present disclosure. Those having ordinary skill in the technical field of the present disclosure can make any modifications and changes in the form and details of the implementation without departing from the spirit and scope disclosed in the present disclosure, however, the scope of patent protection of the present disclosure must still be subject to the scope defined by the appended claims.

1. A data anomaly statistics and alarm method, comprising:
step a: acquiring a detection time and a detection result of each of a plurality of data respectively through detecting;
step b: counting the number of target data in a current time window, and generating an alarm signal to prompt in response to the number of target data obtained by the counting being greater than a preset number threshold corresponding to a quality level of the data, wherein the target data is the one with the detection result being anomalous; and
step c: moving the current time window backward according to an obtained stepping duration setting rule corresponding to the quality level of the data, the current time window moved backward being used as a new current time window, and returning to step a.

2. The data anomaly statistics and alarm method of claim 1, wherein the method further comprises:
acquiring the number of alarm signals generated within a preset period of time;
the step of moving the current time window backward according to an obtained stepping duration setting rule corresponding to the quality level of the data comprises:
acquiring a target stepping duration corresponding to the number from the stepping duration rule corresponding to the quality level of the data, wherein, the stepping duration setting rule comprises a plurality of preset numbers of alarm signals generated within the preset duration and a stepping duration corresponding to each of the plurality of preset numbers; and
moving the current time window backward according to the target stepping duration.

3. The data anomaly statistics and alarm method of claim 1, wherein acquiring a detection time and a detection result of each of a plurality of data respectively through detecting comprises:
acquiring the detection time and the detection result of each of the plurality of data respectively through detecting multiple data within a set duration threshold before a current time, wherein, the set duration threshold is greater than a time window length of the current time window, and a starting time of the current time window is within the set duration threshold before the current time.

4. The data anomaly statistics and alarm method of claim 1, wherein the quality level of the data comprises a first level, a second level, and a third level, and the first level is superior to the second level, and the second level is superior to the third level.

5. The data anomaly statistics and alarm method of claim 4, the stepping duration corresponding to the data of the first level is less than the stepping duration corresponding to the data of the second level, the stepping duration corresponding to the data of the second level is less than the stepping duration corresponding to the data of the third level.

6. The data anomaly statistics and alarm method of claim 4, wherein the time window length of the current time window is one day or two days, and the stepping duration corresponding to the data of the first level is ten minutes, twenty minutes or one hour, the stepping duration corresponding to the data of the second level is four hours or half a day, and the stepping duration corresponding to the data of the third level is one day or two days.

7. The data anomaly statistics and alarm method of claim 4, wherein the preset number threshold corresponding to the data of the first level is smaller than the preset number threshold corresponding to the data of the second level, the preset number threshold corresponding to the data of the second level is smaller than the preset number threshold corresponding to the third level of data.

8. The data anomaly statistics and alarm method of claim 1, wherein acquiring a detection time and a detection result of each of a plurality of data respectively through detecting comprises:
acquiring the detection time and the detection result of each of the plurality of data respectively through detecting at every interval set duration, wherein the set duration is less than or equal to the stepping duration.

9. A data anomaly statistics and alarm apparatus, comprising a processor, wherein the processor is configured to execute the following program modules stored in a memory:
an information acquiring module configured to acquire a detection time and a detection result of each of a plurality of data respectively through detecting;
an anomaly statistics and alarm module configured to count the number of target data in a current time window, and generate an alarm signal to prompt in response to the number of target data obtained by the counting being greater than a preset number threshold corresponding to a quality level of the data, wherein the target data is the one with the detection result being anomalous; and
a time window setting module configured to move the current time window backward according to an obtained stepping duration setting rule corresponding to the quality level of the data, wherein the current time window moved backward is used as a new current time window.

10. A storage medium storing a computer program which, when executed by one or more processors, causes the one or more processors to perform the data anomaly statistics and alarm method of claim 1.

11. An electronic device, comprising a memory and a controller, and a computer program is stored in the memory, when the computer program is executed by the controller, the data anomaly statistics and alarm method of claim 1 is performed.
